(19) United States
(12) Patent Application Publication
(10) Pub. No.: US 2021/0182981 A1
(43) Pub. Date: Jun. 17, 2021

(54) ENERGY DISTRIBUTION METHOD USING DYNAMIC PRICE OF ENERGY AND ENERGY BROKER APPARATUS PERFORMING THE METHOD

(71) Applicant: Electronics and Telecommunications Research Institute, Daejeon (KR)

(72) Inventors: Yoon-Sik YOO, Daejeon (KR); IL Woo LEE, Daejeon (KR)

(73) Assignee: Electronics and Telecommunications Research Institute, Daejeon (KR)

(21) Appl. No.: 17/109,888

(22) Filed: Dec. 2, 2020

(30) Foreign Application Priority Data
Dec. 13, 2019 (KR) 10-2019-0166582
Nov. 10, 2020 (KR) 10-2020-0149158

(51) Int. Cl. G06Q 50/06; H02J 3/00; G06Q 10/04; G05F 1/66; H02J 3/46

(52) U.S. Cl. CPC G06Q 50/06; H02J 3/004; H02J 3/46; G05F 1/66; G06Q 10/04

(57) ABSTRACT

An energy distribution method using a dynamic price of energy and an energy broker apparatus performing the method are provided. The energy distribution method transmits a generated amount of generation energy produced from distributed resources held by an energy provider as optimal energy to be used by demand resources and loads of the energy consumer in response to a request from an energy consumer. In addition, the energy distribution method generates a profit by reselling excess energy produced from the demand resources of the energy consumer to a market at an optimal price.

### CROSS-REFERENCE TO RELATED APPLICATION(S)

This application claims the benefit of Korean Patent Application No. 10-2019-0166582, filed on Dec. 13, 2019, and Korean Patent Application No. 10-2020-0149158 filed on Nov. 10, 2020, in the Korean Intellectual Property Office, the entire disclosures of which are incorporated herein by reference for all purposes.

### BACKGROUND

### 1. Field of the Invention

One or more example embodiments relate to an energy distribution method using a dynamic price of energy and an energy broker apparatus, and more particularly, to a method and apparatus that uses a dynamic price of energy produced from distributed resources to improve a utility between an energy provider and an energy consumer.

### 2. Description of the Related Art

In the past, in order to use distributed energy resources supplied, demand resources have been used for energy requested by a consumer through energy retailers based on a single form of distributed resources. However, in this method, an efficient use of energy was limited due to a fixed energy price.

In addition, since renewable energy is variable, unpredictable, and intermittent, the balance between supply and demand is important and a demand-side management (DSM) is used to manage consumer demand. For example, an energy provider may directly manage the consumer's demand by maximizing revenue or improving energy efficiency, which is usually based on consensus.

However, this approach presents energy consumer's privacy concerns. Also, energy providers indirectly manage demand of an energy consumer by changing a price of energy, which is called a pricing mechanism. Since the energy consumers manage their demand by themselves based on information on a price determined by providers, the pricing mechanism may affect both consumers and providers.

Therefore, it is important to determine an optimal behavior of the energy consumer or set an energy unit cost optimized for the DSM. However, in the related art, when managing energy demand based on price feedback, a power loss occurring during the energy supply and the impact of competitor's pricing have not been considered comprehensively.

### SUMMARY

An aspect provides an energy distribution method and an energy broker apparatus that may transmit distributed resources of an energy provider as optimal energy that can be used by demand resources and loads of an energy consumer and sell excess energy produced from the demand resources of the energy consumer to the market at an optimal price, thereby improving energy use efficiency and utility.

Another aspect also provides an energy distribution method and an energy broker apparatus that may provide an optimal profit based on availabilities of distributed resources of an energy provider and demand resources and loads of an energy consumer so that user's satisfaction is maximized.

According to an aspect, there is provided an energy distribution method including receiving an energy request message including an amount of energy required for energy supply from an energy consumer, determining, when the energy request message is received, a dynamic price of generation energy produced through distributed resources held by an energy provider for each time slot, and determining an amount of distributed energy to be supplied to the energy consumer based on the dynamic price of the generation energy.

The determining of the dynamic price may include authenticating, when the energy request message is received, the energy consumer using personal identification information included in the energy request message, profiling, when an authentication is completed, an energy use history of the energy consumer using the energy request message transmitted from the energy consumer, and analyzing an energy consumption pattern of the energy consumer based on the profiled energy use history of the energy consumer.

The determining of the amount of distributed energy may include determining an amount of distributed energy to be supplied based on a dynamic price determined in a peak time zone of energy consumption of the energy consumer according to the energy consumption pattern.

The determining of the amount of distributed energy may include determining an amount of distributed energy to be traded by an energy consumer to an energy provider in a time slot based on a sum of utility associated with a plurality of energy consumers capable of energy transaction with the energy provider.

The determining of the amount of distributed energy may include determining, when proceeding energy transaction, an amount of distributed energy to be supplied to the energy consumer such that an amount of energy required by the energy consumer does not exceed a amount of the generation energy to be generated for each time slot of the energy consumer.

The determining of the amount of distributed energy may include determining an amount of distributed energy to be supplied based on energy consumed by the energy consumer in the time slot, a maximum amount of energy to be charged in an energy storage device of the energy consumer, and energy traded to the energy provider.

The determining of the amount of distributed energy may include determining an amount of distributed energy to be supplied to the energy consumer based on whether demand resources held by the energy consumer is present and an amount of energy demanded according to the energy consumption pattern of the energy consumer.

The determining of the amount of distributed energy may include verifying whether excess energy produced from demand resources held by the energy consumer is present based on the energy consumption pattern of the energy consumer, and determining, when the excess energy is present, an energy distribution energy in which a charging amount of excess energy is subtracted based on the amount of required energy.

According to another aspect, there is also provided an energy distribution method including receiving an energy request message based on energy consumption of an energy consumer and analyzing an energy consumption pattern according to an energy use history of the energy consumer, setting a dynamic price for performing energy transaction with the energy consumer based on a generated amount of energy produced from distributed resources held by an energy provider, determining an amount of distributed energy to be supplied to the energy consumer for each time slot based on the energy consumption pattern and the dynamic price, and determining, when transaction between the energy consumer and the energy provider is completed, an incentive corresponding to a profit of the energy provider and/or a profit of the energy consumer generated during the energy transaction.

The determining of the amount of distributed energy may include determining an amount of distributed energy to be supplied based on a dynamic price determined in a peak time zone of energy consumption of the energy consumer according to the energy consumption pattern.

The determining of the amount of distributed energy may include determining an amount of distributed energy to be supplied for each time slot based on an excess energy amount of demand resources held by the energy consumer.

According to another aspect, there is also provided an energy broker apparatus performing an energy distribution method, the apparatus including a processor, wherein the processor is configured to receive an energy request message including an amount of energy required for energy supply from an energy consumer, determine, when the energy request message is received, a dynamic price of generation energy produced through distributed resources held by an energy provider for each time slot, and determine an amount of distributed energy to be supplied to the energy consumer based on the dynamic price of the generation energy.

The processor may be configured to authenticate, when the energy request message is received, the energy consumer using personal identification information included in the energy request message, profile, when an authentication is completed, an energy use history of the energy consumer using the energy request message transmitted from the energy consumer, and analyze an energy consumption pattern of the energy consumer based on the profiled energy use history of the energy consumer.

The processor may be configured to determine an amount of distributed energy to be supplied based on a dynamic price determined in a peak time zone of energy consumption of the energy consumer according to the energy consumption pattern.

The processor may be configured to determine an amount of distributed energy to be traded by an energy consumer to an energy provider in a time slot based on a sum of utility associated with a plurality of energy consumers capable of energy transaction with the energy provider.

The processor may be configured to determine an amount of distributed energy to be supplied based on energy consumed by the energy consumer in the time slot, a maximum amount of energy to be charged in an energy storage device of the energy consumer, and energy traded to the energy provider.

The processor may be configured to verify whether excess energy produced from demand resources held by the energy consumer is present based on the energy consumption pattern of the energy consumer, and determine, when the excess energy is present, an energy distribution energy in which a charging amount of excess energy is subtracted based on the amount of required energy.

According to another aspect, there is also provided an energy broker apparatus performing an energy distribution method, the apparatus including a processor, wherein the processor is configured to receive an energy request message based on energy consumption of an energy consumer and analyze an energy consumption pattern according to an energy use history of the energy consumer, set a dynamic price for performing energy transaction with the energy consumer based on a generated amount of energy produced from distributed resources held by an energy provider, determine an amount of distributed energy to be supplied to the energy consumer for each time slot based on the energy consumption pattern and the dynamic price, and determine, when transaction between the energy consumer and the energy provider is completed, an incentive corresponding to a profit of the energy provider and/or a profit of the energy consumer generated during the energy transaction.

The processor may be configured to determine an amount of distributed energy to be supplied based on a dynamic price determined in a peak time zone of energy consumption of the energy consumer according to the energy consumption pattern.

The processor may be configured to determine an amount of distributed energy to be supplied for each time slot based on an excess energy amount of demand resources held by the energy consumer.

According to example embodiments, an energy broker apparatus may optimally distribute energy based on an amount of energy required by an energy consumer through energy transaction according to a dynamic price of time slot-based renewable energy in a case in which the energy consumer requests required energy from an energy provider.

According to example embodiments, an energy broker apparatus may optimally distribute energy based on an amount of energy required by an energy consumer, thereby improving utility of the energy consumer and increasing a profit of the energy consumer.

According to example embodiments, an energy broker apparatus may provide an incentive to an energy provider who has provided energy to an energy consumer according to a degree of energy supply, thereby efficiently using available distributed energy resources and stably and efficiently managing distributed resource energy supply and demand.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an overall operation of performing energy transaction using a dynamic price of energy according to an example embodiment of the present disclosure;

FIG. 2 is an operation flow chart illustrating an energy transaction mechanism based on a dynamic price of energy according to an example embodiment of the present disclosure;

FIG. 3 is a graph showing a utility relationship of an energy consumer for energy transaction based on a dynamic price according to an example embodiment of the present disclosure;

FIG. 4 is a flowchart illustrating an energy distribution method according to an example embodiment of the present disclosure; and

FIG. 5 is a flowchart illustrating an energy distribution method according to another example embodiment of the present disclosure.

### DETAILED DESCRIPTION

The following structural or functional descriptions of examples disclosed in the present disclosure are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component within the scope of the right according to the concept of the present disclosure.

It will be understood that when a component is referred to as being “connected to” another component, the component can be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms including technical or scientific terms used herein have the same meaning as commonly understood by one of ordinary skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, example embodiments will be described in detail with reference to the accompanying drawings, and like reference numerals in the drawings refer to like elements throughout.

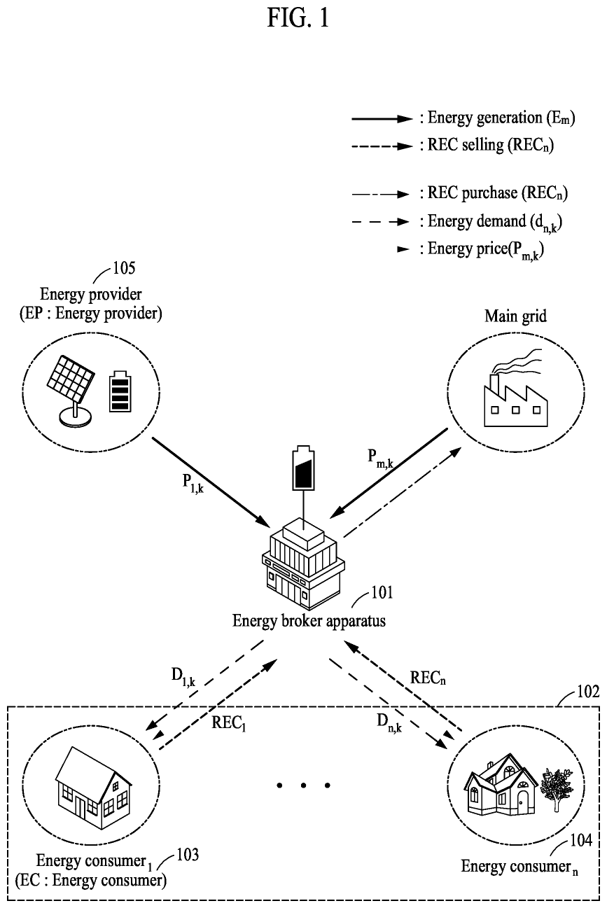

FIG. 1 is a diagram illustrating an overall operation of performing energy transaction using a dynamic price of energy according to an example embodiment of the present disclosure.

Referring to FIG. 1, an energy broker apparatus 101 may perform optimal energy distribution according to required energy corresponding to an energy request of the energy consumer 102 and excess energy resold by an energy consumer 102 based on distributed resources from an energy provider 105. Here, the energy provider 105 may transfer a generated amount of generation energy produced from available distributed resources to the energy broker apparatus 101. The energy broker apparatus 101 may provide the generated amount of generation energy received from the energy provider 105 and a unit cost for producing the generation energy.

The energy consumer 102 may send an energy request message for energy supply to the energy broker apparatus 101 to use energy of the distributed resources. In addition, the energy consumer 102 may resell excess energy of demand resources.

The energy broker apparatus 101 may register available distributed resources of energy in response to a request from the energy provider 105. The energy provider 105 may request the energy broker apparatus 101 to register the available distributed resources and the generated amount of generation energy produced from the distributed resources. The energy broker apparatus 101 may register the available distributed resources and the generated amount of generation energy in response to the request from the energy provider 105.

When an amount of required energy is requested from the energy consumer 102, the energy broker apparatus 101 may calculate energy to be distributed to the energy consumer 102 based on the amount of required energy and suggest the calculated energy.

More specifically, the energy broker apparatus 101 may receive an energy request message including the amount of energy required by the energy consumer 102. The energy broker apparatus 101 may evaluate the energy request message of the energy consumer 102. In other words, the energy consumer 102 may periodically request the amount of required energy by time unit. The energy broker apparatus 101 may transmit, to the energy consumer 102, whether the request energy (the amount of required energy) is to be supplied by the time unit and a price of the energy. The energy consumer 102 may determine whether to use the energy based on the energy amount and price. In addition, if there is stored excess energy remaining after being produced and consumed by itself, the energy consumer 102 may request the energy broker apparatus 101 to sell REC to sell the REC to the energy provider.

Accordingly, the energy broker apparatus 101 may evaluate optimal energy to be distributed to the energy consumer 102 based on an REC's selection condition for consumer's excess energy, an energy price of the energy provider, and an amount of energy required by a consumer.

The energy broker apparatus 101 may profile the evaluated energy request message and analyze an energy use history of the energy consumer for the profiled energy request message. Also, the energy broker apparatus 101 may categorize information for energy distribution and transaction of the distributed resources based on a time slot of a time unit according to a point in time at which a request for energy supply is made. In other words, the energy broker apparatus 101 may provide real-time energy supply and transaction functions by categorizing supply resources held by the energy provider 105, the demand resources held by the energy consumer 102, an amount of energy required for a load, and a charging amount of excess energy.

The energy broker apparatus 101 may provide energy to the energy consumer 102 transmitting the energy request message based on the categorized data. For example, the energy consumer 102 may be a plurality of energy consumers. Energy consumers 103 and 104 may each transmit an energy request message to the energy broker apparatus 101 at the time when energy is required. The energy broker apparatus 101 may provide the energy to each of the energy consumers 103 and 104 based on an amount of required energy included in the energy request message transmitted from the energy consumers 103 and 104.

For this, the energy broker apparatus 101 may determine an amount of distributed energy to be distributed to the energy consumer 102 according to the requested amount of required energy based on an analysis result.

More specifically, when an analysis is completed, the energy broker apparatus 101 may calculate an amount of distributed energy corresponding to the energy request message according to the demand resources and loads for each of the energy consumer who requests the required energy.

The energy broker apparatus 101 may update (or list-up) available distributed energy resources and an amount of distributed energy for optimal transaction such that excess energy of the demand resources held by the energy consumer 102 is traded. The energy broker apparatus 101 may induce the energy consumer to resell the excess energy for each energy request message in accordance with the updating. In such process, the energy provider 105 having contributed to the energy supply may be provided with an incentive based on a contribution to the energy supply. Also, the energy consumer may be provided with a profit for excess energy transaction.

Here, to manage the energy distribution for energy transaction based on a dynamic price, the present disclosure may maximize a sum of utility of all the energy consumers 102 under the concept of benefit of the energy broker apparatus 101. In this view, U(x_{i,k},δ_{i,k},s_{i,k}) denotes a utility of an energy consumer_{i,k}. U(x,δ,s) denotes a total utility. Accordingly, the present disclosure may obtain an optimal profit and consider optimization by increasing the utility of all the energy consumers based on the demand resources and loads as shown in Equation 1 below.

U(x,δ,s)=Σ_{i∈N,k∈K}U(x_{i,k},δ_{i,k},s_{i,k}) [Equation 1]

In Equation 1, the energy broker apparatus 101 may not allocate energy more than the amount of required energy requested from the energy consumer 102, and obtain and optimize a profit if a condition that a sum of all the allocated energy cannot exceed remaining energy of all the energy providers 105 is satisfied.

For this, U(x_{i,k},δ_{i,k},s_{i,k}) is defined as the utility of the energy consumer_{i,k} in view of the energy broker apparatus 101. Defining the following assumptions and the meaning thereof with respect to U(x_{i,k},δ_{i,k},s_{i,k}), U(x_{i,k},δ_{i,k},s_{i,k}) is a nonnegative real-valued function, wᵢx_{i,k} is a strictly increasing function, and x_{i,k} is a concave function. In addition, a quadratic utility function may be generally used for measuring a user's utility using characteristics of the demand resources held by the energy consumer 102.

Accordingly, Equation 2 may be considered as a utility function of the energy consumer_{i,k} in view of the energy broker apparatus 101.

$$U ( {x}_{i , k} , {δ}_{i , k} , {s}_{i , k} ) = \{ \begin{matrix}{w}_{i} {x}_{i , k} - \frac{{w}_{i}}{2 {δ}_{i , k}} - {s}_{i , k} , & if 0 \leq {x}_{i , k} \leq {δ}_{i , k} \\ \frac{{w}_{i} {δ}_{i , k}}{2} - {s}_{i , k} , & if {x}_{i , k} \geq {δ}_{i , k}\end{matrix} \qquad [ Equation 2 ]$$

If K={1, 2, . . . , N} is a time index set of all the energy consumers 102, x_{i,k} is an amount of energy consumed in a k-th time slot of an i-th energy consumer. Wᵢ denotes a preference of the i-th consumer. δ_{i,k} is a maximum amount of energy to be charged in an ESS in the k-th time slot of the i-th energy consumer. S_{i,k} is an amount of energy traded by a consumer to the energy broker apparatus 101 in the k-th time slot of the i-th energy consumer.

Accordingly, an energy distribution policy for energy transaction according to a dynamic price of time slot-based renewable energy may be expressed as Equation 3 below.

$${maximize}_{H} {{\sum }^{N}}_{i} {{\sum }^{K}}_{k} ( ω U ( {x}_{i , k} , {δ}_{i , k} , {s}_{i , k} ) - {C}_{ESS} ( {e}_{i , k} ) - {C}_{REW} ( {g}_{t , k} ) ) \\ + {{\sum }^{K}}_{k} ( F ( {R}_{k} ) - {C}_{G} ( {G}_{k} ) ) \\ subject to {{\sum }^{N}}_{i} ( {x}_{i , k} + {e}_{i , k} - {g}_{i , k} ) \leq {G}_{k} , ∀ k ∈ K \\ {{\sum }^{N}}_{i} {g}_{i , k} = {R}_{k} , ∀ k ∈ K \qquad [ Equation 3 ]$$

where, H={x_{i k},δ_{i k}, s_{i k}, e_{i k},g_{i k}|i∈N,k∈K}, ω: weight factor

However, C_{ESS}(e_{i,k}) is an energy charging and discharging cost of an energy storage device (e.g., ESS). C_{REW}(g_{i,k}) is an PV operation cost. F(Rₖ) is a profit obtained from renewable energy transaction. In addition, C_{G}(Gₖ) is an energy generation cost. Also, e_{i,k} is an amount of energy charged or discharged by the energy broker apparatus 101 in the k-th time slot of the i-th energy consumer. g_{i,k} is an amount of renewable energy traded to the energy provider 105 in the k-th time slot of the i-th energy consumer. Rₖ is r unit is renewable energy. In addition, Gₖ is energy produced by the energy provider 105 in the time slot k. Also, a constraint condition indicates that the demand of the energy consumer, a charging and discharging amount of the energy storage device, and a usage of PV are to be less than a provider's energy production and indicates that an amount of PV production is to be the same as a total amount of renewable energy.

Here, since an objective function is strictly concave and constraints are linear, Equation 4 is given below according to Lagrangian and Duality conditions.

$$ℒ ( H , ν , o ) = {{\sum }^{N}}_{i} {{\sum }^{K}}_{k} ( ω U ( {x}_{i , k} , {δ}_{i , k} , {s}_{i , k} ) - {C}_{ESS} ( {e}_{i , k} ) - {C}_{REW} ( {g}_{t , k} ) ) \\ + {{\sum }^{K}}_{k} ( F ( {R}_{k} ) - {C}_{G} ( {G}_{k} ) ) \\ - {{\sum }^{K}}_{k} {ν}_{k} ( {{\sum }^{N}}_{i} ( {x}_{i , k} + {e}_{i , k} - {g}_{i , k} ) - {G}_{k} ) \\ + {{\sum }^{K}}_{k} {O}_{k} ( {{\sum }^{N}}_{i} {g}_{i , k} - {R}_{k} ) \qquad [ Equation 4 ]$$

This may have an optimal solution since the objective function and an inequality constraint function is differentiable and convex, and an equality constraint function is affine. Accordingly, an optimal energy transaction policy of x*={x_{i,k}*|i∈N,k∈K} may be determined as shown in Equation 5 below.

g(v,o)=max_{H} [symbol] (H,v,o)

[symbol]

(v,o)=min_{v≥0,o}g(v,o) [Equation 5]

By performing the above-described series of processes, the present disclosure may manage the energy distribution for energy transaction according to the dynamic price. In addition, the present disclosure provides a function of reselling the excess energy of the energy consumer 102 in the energy market, thereby gaining a profit.

When providing the energy, the energy broker apparatus 101 may incorporate a charging amount of the excess energy produced from the demand resources held by the energy consumer 102. Accordingly, the energy consumer 102 may perform an operation of a prosumer capable of not only receiving energy but also selling the energy. The energy consumer 102 may gain a profit from the resold excess energy and be provided with an incentive corresponding to the profit. Also, the energy broker apparatus 101 may provide an incentive corresponding to the energy supply to the energy provider 105 having provided the energy to the energy consumer 102.

As a result, when requesting the energy supply from typical distributed energy resources, if the energy should be supplied and transmitted at a fixed price through consumer's demand resources and loads, it is possible to improve energy distribution satisfaction and solve an energy utility improvement problem by classifying into i) a case of receiving energy unnecessary to the consumer and ii) a case of improving profit satisfaction by reselling excess energy produced in the demand resources of the consumer to a market.

Accordingly, it is possible to increase a profit to be achieved by a consumer and increase an availability by using energy supplied to the demand resources and loads for various distributed resources and reselling the excess energy produced from the demand resources of the consumer at a dynamic price to the market. In addition, in the present disclosure, it is possible to build an optimal energy distribution managing infrastructure based on a dynamic price of renewable energy for energy transaction by meeting a demand management of improved distributed resources to be managed through an efficient energy provision.

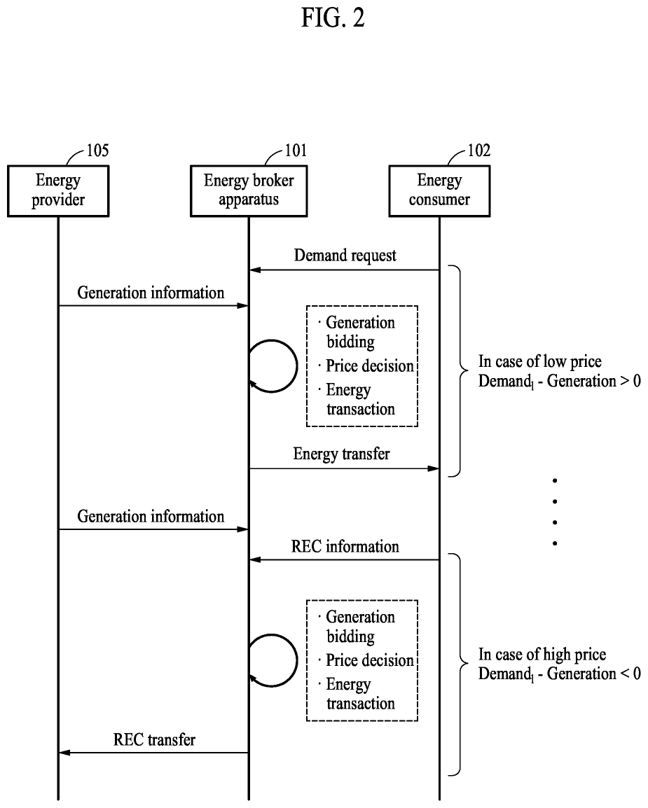

FIG. 2 is an operation flow chart illustrating an energy transaction mechanism based on a dynamic price of energy according to an example embodiment of the present disclosure.

Referring to FIG. 2, the energy broker apparatus 101 may manage energy distribution among an energy provider, an energy broker, and an energy consumer for energy transaction according to a dynamic price of renewable energy based on a time slot for optimizing a consumer's profit based on an energy request message.

When a demand based on an energy consumption pattern is greater than a generation, the energy consumer 102 may request demand information (e.g., an energy request message) from the energy broker apparatus 101. The energy provider 105 may provide power generation information to the energy broker apparatus 101. Here, the power generation information may be information for registering a charging amount of generation energy produced at preset intervals.

The energy broker apparatus 101 may calculate a generated amount of generation energy produced from distributed resources held by the energy provider 105 enough to meet an amount of energy demanded by the energy consumer 102. The energy broker apparatus 101 may determine a generation price obtained at the time when supply meets demand, to be a system marginal price (SMP), that is, a market price. A price model of a main grid may be priced in a power exchange according to the low of supply and demand.

In terms of the renewable energy, when the energy provider 105 suggests a generated amount and a generation price of the generation energy, the energy consumer 102 may adjust an amount of energy demand based on the generation price so that a price and demand are determined.

When the dynamic price and the generated amount of the generation energy for energy transaction are determined, and when the transaction accordingly is determined, the energy provider 105 may feed to deliver the energy to the energy consumer 102 at the time of the transaction.

In addition, when the generation of the energy consumer 102 exceeds the demand, the energy broker apparatus 101 may receive the generation information from the energy provider 105, and the energy consumer 102 may provide REC information. The energy broker apparatus 101 may calculate the generation information and the REC information and transmit REC to the energy provider 105. Therefore, the energy consumer 102 may request and consume energy in a non-peak time zone of the demand resources, and when excess energy is generated, may trade the energy in the peak time zone, thereby optimizing a profit.

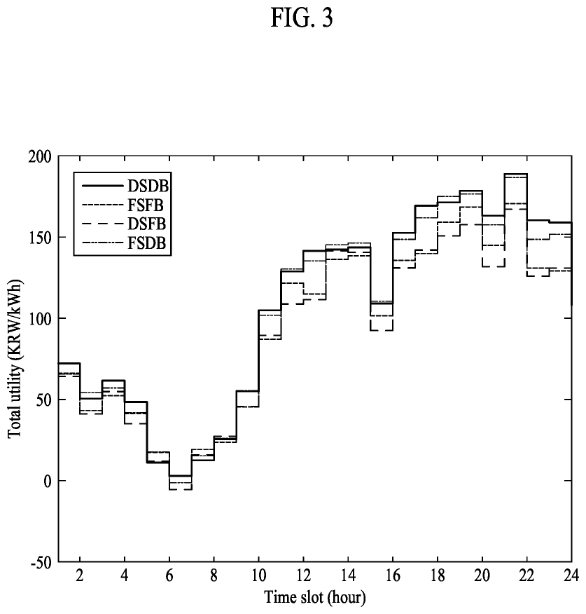

FIG. 3 is a graph showing a utility relationship of an energy consumer for energy transaction based on a dynamic price according to an example embodiment of the present disclosure.

The graph of FIG. 3 shows a utility relationship of an energy consumer for energy transaction based on a dynamic price of time slot-based renewable energy according to the present disclosure.

A case of optimal energy allocation for energy transaction based on a dynamic price is assumed. Under such assumption, when it is the pick time according to the energy consumption pattern of the energy consumer, or when the energy transaction is requested in an emergency, but an amount of generation energy generated by the energy provider is insufficient, the present disclosure may lead to using excess energy of the energy consumer or to purchasing the generation energy at a dynamic price.

In addition, when excess energy of the energy consumer is generated, the present disclosure may induce the energy consumer to resell the excess energy and gain a profit. Through this, energy efficiency may be improved so that the energy is optimally distributed to demanded resources and loads.

Further, compared to a case in which the energy transaction is performed based on a fixed price (e.g., FSFB), a utility of the energy consumer may be more improved when the energy transaction is performed based on a dynamic price (e.g., DSDB) of the renewable energy. Also, in view of the energy consumer that possesses the demand resources, the energy use efficiency and improvement in satisfaction may be achieved.

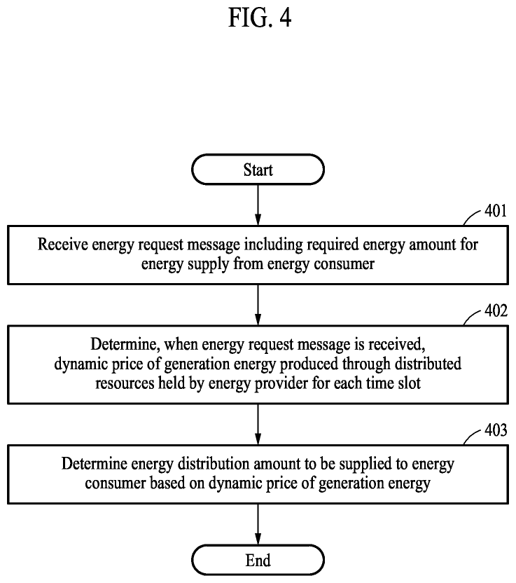

FIG. 4 is a flowchart illustrating an energy distribution method according to an example embodiment of the present disclosure.

In operation 401, an energy broker apparatus may receive an energy request message including an amount of energy required for energy supply from an energy consumer. The energy consumer may transmit an energy request message including an amount of energy required by the energy consumer as required energy for receiving energy required based on energy consumption. The energy broker apparatus may receive energy request messages including different amounts of required energy from one of more energy consumers.

In operation 402, when the energy request message is received, the energy broker apparatus may determine a dynamic price of generation energy produced through distributed resources held by the energy provider for each time slot. The energy broker apparatus may analyze an energy consumption pattern of the energy consumer. In other words, when the energy request message is received, the energy broker apparatus may authenticate the energy consumer who requested energy supply using personal identification information included in the energy request message. Here, when authenticating, the energy broker apparatus may verify whether the energy consumer sending the energy request message is an energy consumer previously registered in a power grid.

When the energy consumer is authenticated, the energy broker apparatus may update the energy request message sent from the energy consumer and profile an energy use history of the energy consumer based on the updated energy request message. The energy broker apparatus may analyze the energy consumption pattern of the energy consumer based on the profiled energy use history of the energy consumer.

The energy broker apparatus may distinguish between a peak time zone and a non-peak time zone of energy according to the amount of required energy of the energy request message recorded and accumulated in the energy use history. The energy broker apparatus may analyze the energy consumption pattern of the energy consumer by analyzing daily, monthly, and annual energy consumption of the energy consumer according to the distinguished time zones.

When the energy consumption pattern of the energy consumer is analyzed, the energy broker apparatus may determine a dynamic price of generation energy produced through distributed resources held by the energy provider for each time slot. At this time, the energy provider may request the energy broker apparatus to register a charging amount of the generation energy produced at preset time intervals. The energy broker apparatus may register the charging amount of the generation energy for each energy provider in response to the request from the energy provider. The energy broker apparatus may determine a dynamic price of the generation energy to be the same or different for each time slot of time unit.

In operation 403, the energy broker apparatus may determine an amount of distributed energy to be supplied to the energy consumer based on the dynamic price of the generation energy. For this, the energy broker apparatus may determine an amount of distributed energy to be supplied based on a dynamic price determined in a peak time zone of energy consumption of the energy consumer according to the energy consumption pattern.

To optimize profits of the energy provider and the energy consumer, the energy broker apparatus may determine an amount of distributed energy to be traded by the energy consumer to the energy provider in a time slot based on a sum of utility associated with a plurality of energy consumers capable of energy transaction with the energy provider. Also, the energy broker apparatus may determine an amount of distributed energy to be supplied to the energy consumer such that an amount of energy required by the energy consumer does not exceed a amount of the generation energy to be generated for each time slot of the energy consumer.

To increase an energy use efficiency, the energy consumer not only request the energy supply, but may also utilize excess energy produced from demand resources held by the energy consumer. For this, the energy broker apparatus may verify whether excess energy produced from demand resources held by the energy consumer is present based on the energy consumption pattern of the energy consumer. When the excess energy is present, the energy broker apparatus may determine an energy distribution energy in which a charging amount of excess energy is subtracted based on the amount of required energy.

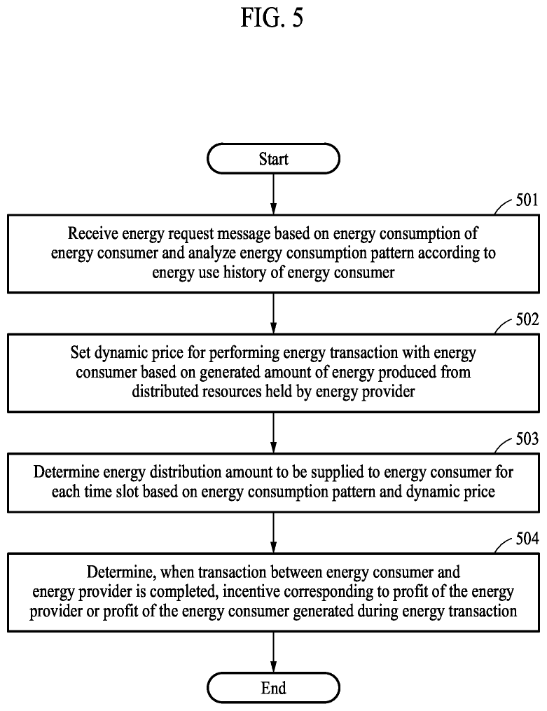

FIG. 5 is a flowchart illustrating an energy distribution method according to another example embodiment of the present disclosure.

In operation 501, the energy broker apparatus may receive an energy request message based on energy consumption of an energy consumer and analyze an energy consumption pattern according to an energy use history of the energy consumer. Specifically, when an energy provider requests an amount of required energy to the energy broker apparatus, the energy broker apparatus may evaluate the energy request message of the energy consumer. In addition, the energy broker apparatus may profile the evaluated energy request message and analyze an energy use history of the energy consumer for the profiled energy request message. The energy broker apparatus may analyze an energy consumption pattern according to the energy use history of the energy consumer.

In operation 502, the energy broker apparatus may set a dynamic price for performing energy transaction with the energy consumer based on a generated amount of energy produced from distributed resources held by an energy provider. Here, the dynamic price may be determined as a power generation price obtained at the time when a generated amount of generation energy produced through distributed resources held by the energy provider satisfies the amount of energy required by the energy consumer, that is, a market price.

In operation 503, the energy broker apparatus may determine an amount of distributed energy to be supplied to the energy consumer for each time slot based on the energy consumption pattern and the dynamic price. In this instance, when excess energy produced from demand resources held by the energy consumer exceeds a minimum amount of energy to be charged in an energy storage device of the energy consumer, the energy consumer may resell the excess energy through the energy broker apparatus. By reselling the excess energy, the power consumer may obtain a profit. The energy broker apparatus may determine an amount of distributed energy to be supplied to the energy consumer based on the generated amount of generation energy of the energy provider and a charging amount of the excess energy produced from the demand resources held by the energy consumer.

In operation 504, when transaction between the energy consumer and the energy provider is completed, the energy broker apparatus may determine an incentive corresponding to a profit of the energy provider and/or a profit of the energy consumer generated during the energy transaction.

The energy broker apparatus may determine and provide an incentive corresponding to a profit of the energy consumer and/or a profit of the energy provider generated in an energy transaction process based on the transaction between the energy consumer and the energy provider or the transaction between the energy consumer and a prosumer-concept energy consumer.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The example embodiments described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter.

The above-described hardware devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An energy distribution method comprising:
receiving an energy request message comprising an amount of energy required for energy supply from an energy consumer;
determining, when the energy request message is received, a dynamic price of generation energy produced through distributed resources held by an energy provider for each time slot; and
determining an amount of energy distribution to be supplied to the energy consumer based on the dynamic price of the generation energy.

2. The energy distribution method of claim 1, wherein the determining of the dynamic price comprises:
authenticating, when the energy request message is received, the energy consumer using personal identification information included in the energy request message;
profiling, when an authentication is completed, an energy use history of the energy consumer using the energy request message received from the energy consumer; and
analyzing an energy consumption pattern of the energy consumer based on the profiled energy use history of the energy consumer.

3. The energy distribution method of claim 2, wherein the determining of the amount of distributed energy comprises:
determining an amount of distributed energy to be supplied based on a dynamic price determined in a peak time zone of energy consumption of the energy consumer according to the energy consumption pattern.

4. The energy distribution method of claim 1, wherein the determining of the amount of distributed energy comprises:
determining an amount of distributed energy to be traded by an energy consumer to an energy provider in a time slot based on a sum of utility associated with a plurality of energy consumers capable of energy transaction with the energy provider.

5. The energy distribution method of claim 1, wherein the determining of the amount of energy distribution comprises:
determining, when proceeding energy transaction, an amount of distributed energy to be supplied to the energy consumer such that an amount of energy required by the energy consumer does not exceed an amount of the generation energy to be generated for each time slot of the energy consumer.

6. The energy distribution method of claim 1, wherein the determining of the amount of distributed energy comprises:
determining an amount of distributed energy to be supplied based on energy consumed by the energy consumer in the time slot, a maximum amount of energy to be charged in an energy storage device of the energy consumer, and energy traded to the energy provider.

7. The energy distribution method of claim 2, wherein the determining of the amount of distributed energy comprises:
determining an amount of distributed energy to be supplied to the energy consumer based on whether demand resources held by the energy consumer is present and an amount of energy demanded according to the energy consumption pattern of the energy consumer.

8. The energy distribution method of claim 2, wherein the determining of the amount of distributed energy comprises:
verifying whether excess energy produced from demand resources held by the energy consumer is present based on the energy consumption pattern of the energy consumer; and
determining, when the excess energy is present, an amount of distributed energy in which a charging amount of excess energy is subtracted based on the amount of required energy.

9. An energy distribution method comprising:
receiving an energy request message based on energy consumption of an energy consumer and analyzing an energy consumption pattern according to an energy use history of the energy consumer;
setting a dynamic price for performing energy transaction with the energy consumer based on a generated amount of energy produced from distributed resources held by an energy provider;
determining an amount of distributed energy to be supplied to the energy consumer for each time slot based on the energy consumption pattern and the dynamic price; and
determining, when transaction between the energy consumer and the energy provider is completed, an incentive corresponding to a profit of the energy provider and/or a profit of the energy consumer generated during the energy transaction.

10. The energy distribution method of claim 9, wherein the determining of the amount of distributed energy comprises:
determining an amount of distributed energy to be supplied based on a dynamic price determined in a peak time zone of energy consumption of the energy consumer according to the energy consumption pattern.

11. The energy distribution method of claim 9, wherein the determining of the amount of distributed energy comprises:
determining an amount of distributed energy to be supplied for each time slot based on an excess energy amount of demand resources held by the energy consumer.

12. An energy broker apparatus performing an energy distribution method, the apparatus comprising:
a processor,
wherein the processor is configured to:
receive an energy request message comprising an amount of energy required for energy supply from an energy consumer;
determine, when the energy request message is received, a dynamic price of generation energy produced through distributed resources held by an energy provider for each time slot; and
determine an amount of distributed energy to be supplied to the energy consumer based on the dynamic price of the generation energy.

13. The energy broker apparatus of claim 12, wherein the processor is configured to:
authenticate, when the energy request message is received, the energy consumer using personal identification information included in the energy request message;
profile, when an authentication is completed, an energy use history of the energy consumer using the energy request message transmitted from the energy consumer; and
analyze an energy consumption pattern of the energy consumer based on the profiled energy use history of the energy consumer.

14. The energy broker apparatus of claim 13, wherein the processor is configured to determine an amount of distributed energy to be supplied based on a dynamic price determined in a peak time zone of energy consumption of the energy consumer according to the energy consumption pattern.

15. The energy broker apparatus of claim 12, wherein the processor is configured to determine an amount of distributed energy to be traded by an energy consumer to an energy provider in a time slot based on a sum of utility associated with a plurality of energy consumers capable of energy transaction with the energy provider.

16. The energy broker apparatus of claim 12, wherein the processor is configured to determine an amount of distributed energy to be supplied based on energy consumed by the energy consumer in the time slot, a maximum amount of energy to be charged in an energy storage device of the energy consumer, and energy traded to the energy provider.

17. The energy broker apparatus of claim 13, wherein the processor is configured to:
verify whether excess energy produced from demand resources held by the energy consumer is present based on the energy consumption pattern of the energy consumer; and
determine, when the excess energy is present, an energy distribution energy in which a charging amount of excess energy is subtracted based on the amount of required energy.
